(19) United States
(12) Patent Application Publication
(10) Pub. No.: US 2025/0100201 A1
(43) Pub. Date: Mar. 27, 2025

(54) POLYMER EXTRUSION WITH POLYCRYSTALLINE DIAMOND ELEMENTS

(71) Applicant: ExxonMobil Chemical Patents Inc., Baytown, TX (US)

(72) Inventors: Michael W. ACKMAN, Zachary, LA (US); Eric R. LEWIS, Baton Rouge, LA (US); Stephen E. DEHLINGER, Seabrook, TX (US); Scott T. ROGER, Porter, TX (US)

(21) Appl. No.: 18/291,106

(22) PCT Filed: Aug. 4, 2022
(86) PCT No.: PCT/US2022/074551

§ 371 Date: Jan. 22, 2024

Related U.S. Application Data
(60) Provisional application No. 63/231,046, filed on Aug. 9, 2021.

(51) Int. Cl. B29C 48/30; B29C 48/345

(52) U.S. Cl. CPC B29C 48/3003; B29C 48/345; B29C 2793/0027

(57) ABSTRACT

Die plates for polymer extrusion may include a die plate having an entrance face for accepting a polymer flow and an exit face for extruding one or more polymer strands, wherein the exit face including at least one element constructed from polycrystalline diamond. Systems for extruding polymer may include: an extruder, a die plate attached to an outlet of the extruder and having (i) an entrance face for accepting a polymer flow and (ii) an exit face for extruding one or more polymer strands; an array of blades configured to rotate so as to contact and slide along the surface of the die exit face, thereby cutting the one or more polymer strands extruded therethrough; wherein (a) the exit face, (b) the blade array, or (c) each of the exit face and the blade array comprises at least one element constructed from polycrystalline diamond.

### RELATED OF THE INVENTION

This application claims the benefit of U.S. Provisional Application 63/231,046 filed Aug. 9, 2021 entitled “POLYMER EXTRUSION WITH POLYCRYSTALLINE DIAMOND ELEMENTS”, the entirety of which is incorporated by reference herein.

### FIELD OF THE INVENTION

The presently disclosed subject matter relates to extruder systems, as well as die face and pelletizer designs that increase the performance and wear resistance.

### BACKGROUND OF THE INVENTION

In polymer extrusion systems, a polymer may be converted to a molten state and forced through an extrusion die or die plate at high pressure, where the die plate has several (e.g., dozens, hundreds, thousands, etc.) of flow channels ending in small orifices (e.g., approximately 3 mm) that shape the molten polymer. As the polymer product exits the die plate, it contacts a cooling medium (usually water) and begins to solidify. Extrusion systems may also be equipped with a pelletizer that includes an array of rotating blades that cut the polymer exiting the die into small pellets. Pelletized polymer may then be carried by process water flowing across the die face to a centrifugal dryer where water is removed and dry pellets are discharged.

During operation, the rotating blades of the pelletizer are positioned near the exit face of the die plate and, in some cases, may engage and contact the surface of exit face. The shearing action of the pelletizer blades may result in wear on the die surface, the edges of the die holes, the inner diameter of the die holes, and the pelletizer blades themselves. In addition to mechanical wear, other failure modes include cavitation pitting, corrosion, delamination and detachment of nibs and other wear elements on the die face, warpage, damage from polymer additives, and the like. Damage to the die can lead to improper contact between the blades and the die face, which can lead to adverse changes in bulk density and pellet appearance of the finished product. To mitigate damage to the die face, the extruder is shut down and disassembled to remove and replace the die, which can halt production for time periods that may extend from hours to days. Dies are often made from conventional materials such as stainless steel, tungsten, titanium, and the like, and depending on the specific manufacturing technology, die plates must be replaced every 2 to 18 months.

References of potential interest in this regard include: U.S. Pat. Nos. 8,485,284; 8,672,061; 9,067,340; 9,149,954; 9,314,985; 9,481,121; 9,764,387; 10,124,523; US Patent Publication Nos. 2010/0129479, 2014/0147590, 2016/0151952; WIPO Publication No. 2017/21407; as well as CN110468385, CN105538536, and KR101822590.

### SUMMARY OF THE INVENTION

The present invention is directed to extruder systems and die face designs that incorporate one or more polycrystalline diamond elements.

In an aspect, die plates for polymer extrusion may include: a die plate having an entrance face for accepting a polymer flow and an exit face for extruding one or more polymer strands, wherein the exit face includes at least one element constructed from polycrystalline diamond.

In another aspect, systems for extruding polymer may include: an extruder; a die plate attached to an outlet of the extruder and having (i) an entrance face for accepting a polymer flow and (ii) an exit face for extruding one or more polymer strands; and an array of blades configured to rotate so as to contact and slide along the surface of the die exit face, thereby cutting the one or more polymer strands extruded therethrough; wherein (a) the exit face, (b) the blade array, or (c) each of the exit face and the blade array comprises at least one element constructed from polycrystalline diamond. Furthermore, methods are provided herein for extruding molten polymer through such a system for extruding polymer.

In yet another aspect, methods of extruding polymer include: extruding a molten polymer through a die comprising an exit face constructed at least in part from polycrystalline diamond and attached to an outlet of an extruder.

### BRIEF DESCRIPTION OF THE DRAWINGS

FIG. 1A is an illustration showing the exit face of a die plate assembled on an extruder.

FIG. 1B is an illustration depicting a pelletizer engaging with a die exit face.

FIG. 1C is an illustration of a pelletizer blade.

FIG. 2 is a cross-sectional view of a portion of a die plate showing an example of a flow channel having a pocket terminating in a single land and extrusion orifice.

FIG. 3 is a cross-sectional view of a portion of a die plate showing an example of a flow channel having a pocket terminating in multiple lands and extrusion orifices.

FIG. 4 is a cut-away view of the interior of a pelletizer engaging with a die exit face having multiple extrusion orifices per wear face element, in accordance with some embodiments.

FIG. 5 is a cut-away view of the interior of a pelletizer engaging with a die exit face having a plurality of wear face elements in the form of tiles, in accordance with some embodiments.

### DETAILED DESCRIPTION OF THE INVENTION

The present disclosure is directed to extruder systems and die face designs that increase the performance and wear resistance, and also directed to associated methods of extruding polymers through such systems and die faces. Particularly, systems and die face designs may incorporate one or more wear face components constructed from polycrystalline diamond (PCD) that increase the wear resistance and service life of the die plate.

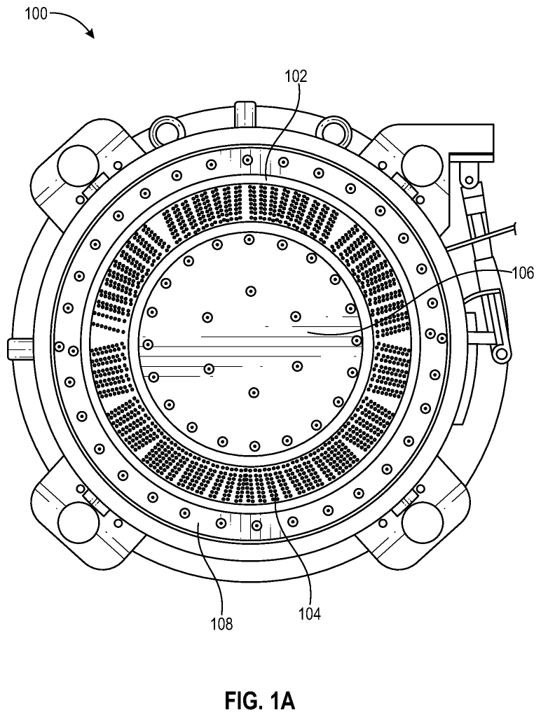

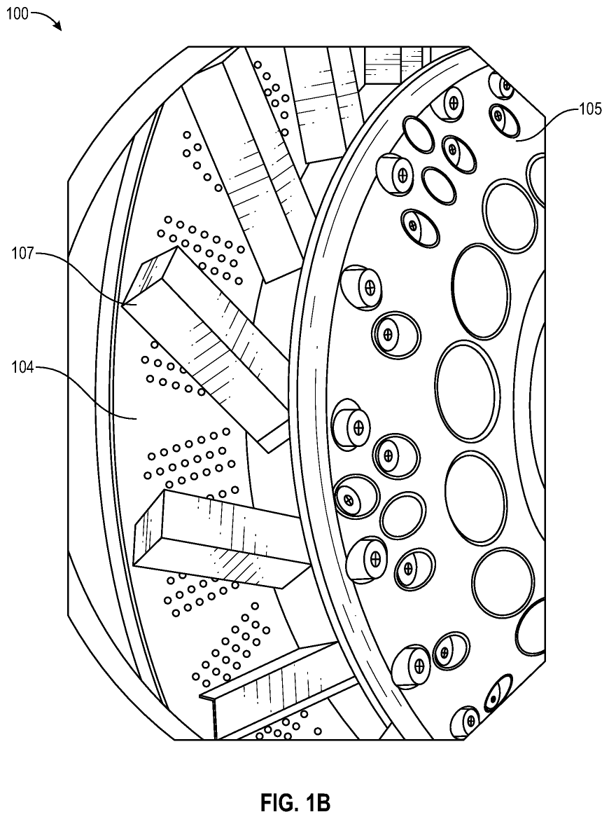

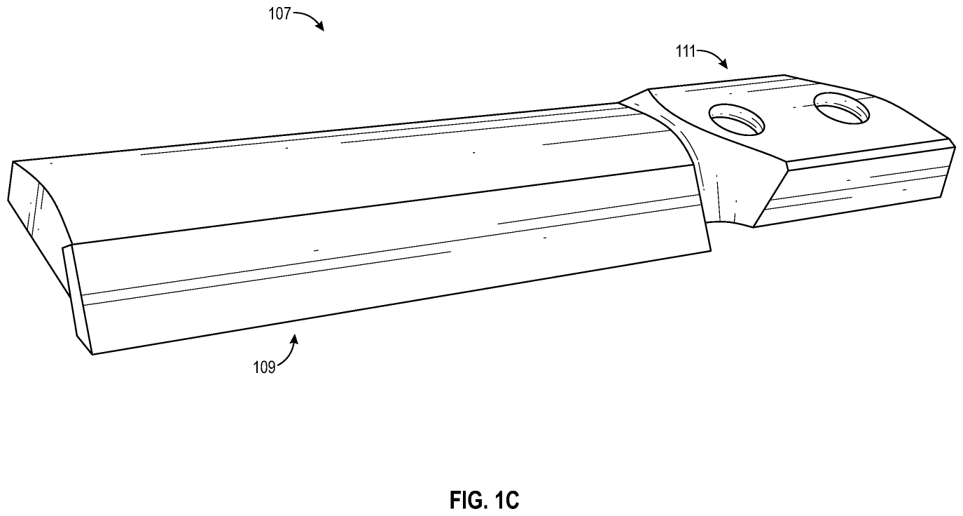

During a polymer extrusion process, polymer is passed through the body of an extruder where the polymer is heated above its melting point or glass transition temperature and converted to a molten state. The molten polymer is then passed to a die plate and through a series of passages or channels of a relatively minute cross-sectional area. FIG. 1A is a schematic end view of an example extruder assembly 100 with an installed die plate 102. A die exit face 104 of the die plate 102 includes a die center cover plate 106 and an outer cover ring 108, which provide a number of features containing extrusion orifices that shape extruded polymer product. As shown in FIG. 1B, die plate 102 may also be engaged with a pelletizer array 105 having an array of blades 107 that contact (or are proximal to) the die exit face 104. As polymer strands are extruded from the die exit face 104 during operation, the pelletizer array 105 cuts the extruded polymer, which is then collected and processed to form a final polymer pellet product.

FIG. 1C is a detailed view of an individual pelletizer blade 107 showing the cutting surface 109 and shank 111 for securing the pelletizer blade 107 to the pelletizer array 105. Pelletizer blade 107 may be a monoblock (monolithic) construction in which cutting surface 109 and blade 107 are prepared from a single material, such as a PCD material. Pelletizer blade 107 may also be a composite or multi-material structure. In an example, the cutting surface 109 may be a first material, such as a PCD material, and the remainder of the blade 107 may be constructed from a different metal or alloy.

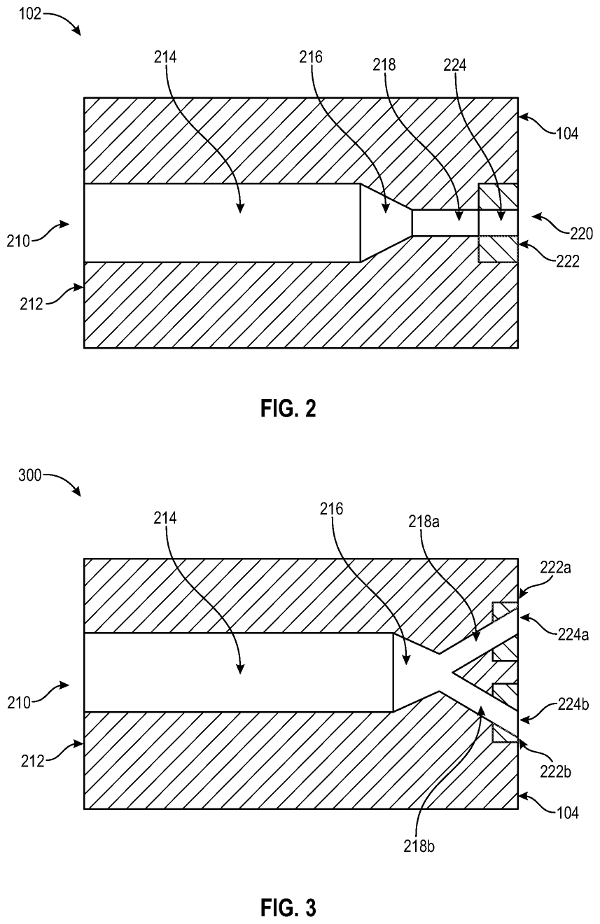

Referring back to FIG. 1A, die plate 102 may include or otherwise define a number of channels and passages that serve to collect and shape the molten polymer during the extrusion process. FIG. 2 is a cross-sectional side view of a segment of the die plate 102. As illustrated, the die plate 102 provides an entrance face 212 positioned opposite the die exit face 104. Moreover, the die plate 102 may define an extrusion channel 210 extending between the entrance face 212 and the die exit face 104, and thus forming a passageway for material to flow through the die plate 102. During extrusion, molten polymer is driven through the extruder and the polymer encounters entrance face 212 and begins to collect in one or more pockets (or slots) 214. The collected polymer is then introduced by way of taper 216 to one or more landings 218 that terminate in an extrusion orifice 220 defined at the die exit face 104.

Die exit face 104 may also include a wear face 222 or other element that is affixed thereto and that defines an orifice 224 that is co-linear with extrusion orifice 220. The type of wear face 222 is not particularly limited and die plates disclosed herein may include single-hole nibs (such as that pictured in FIG. 2) that are embedded within the die exit face 104 proximate a single extrusion orifice 220, but may also include wear faces that define multiple orifices that are assembled or embedded on exit face 104, including tiles, multi-hole nibs, or monolithic wear faces that substantially cover die exit face 104. In another variation, die exit face 104 may be formed from a wear-resistant material such that die exit face 104 and wear face 222 are the same structure.

Alternative die plate designs may include extrusion orifices having angled or deviated landings, such as when multiple extrusion orifices and lands stem (extend) from a single pocket 214 provided in a die plate. FIG. 3 is a cross-sectional side view of a die wear face segment 300, illustrating a die variation in which multiple lands 218a and 218b extend from a single pocket 214. Similar to the structure shown in FIG. 2, an extrusion channel 210 extends between the entrance face 212 of the die plate 102 and the exit face 104. During extrusion, molten polymer is driven through the extruder and the polymer encounters entrance face 102 and collects in pocket (or slot) 214. However, as the polymer collects in pocket 214, taper 216 feeds the molten polymer into multiple lands 218a and 218b, which extend to orifices 224a and 224b, respectively. In this example, die exit face 104 may also include wear faces 222a and 222b that define extrusion orifices 224a and 224b.

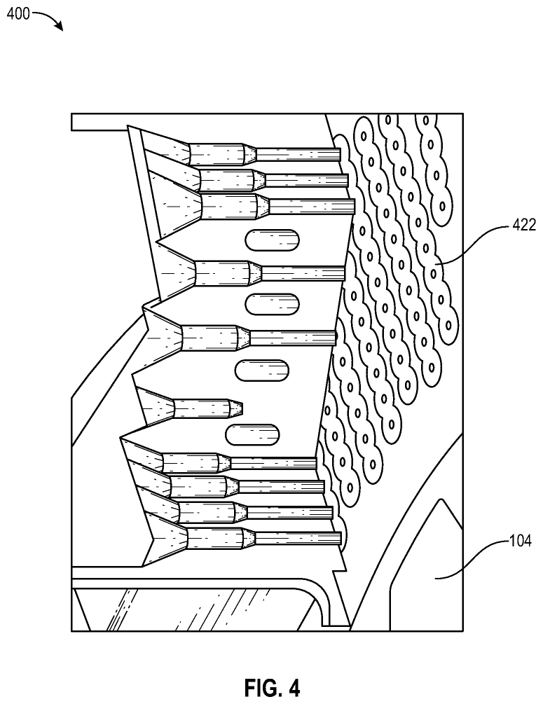

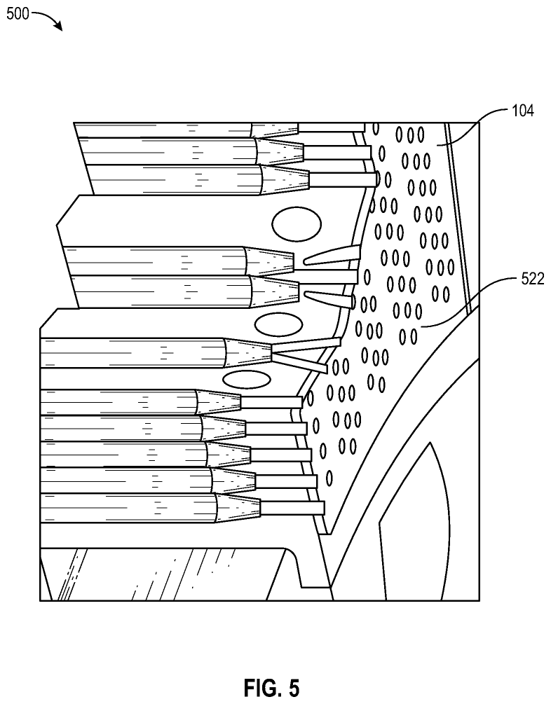

FIG. 4 shows another possible die plate design 400 in which the die exit face 104 has a plurality of wear face elements 422 in the form of multi-hole nibs having multiple extrusion orifices per wear face element 422. Yet another possible die plate design is shown in FIG. 5, showing a die plate design 500 in which die exit face 104 is formed from a plurality of wear face elements 522 in the form of tiles.

During normal operation of an extruder equipped with a pelletizer system, control over polymer pellet size and distribution is handled in a number of ways including internal die geometry design, and monitoring the pressure and polymer flow at the die face for changes during production. Over time, pellet size and product quality may be affected by a number of process conditions, including damage to the die exit face and wear face components from mechanical wear and abrasion from interaction with the pelletizer blades. Over time, mechanical damage to the die face and extrusion orifices can cascade into wear face detachment and damage to the pelletizer system.

Conditions at the die face may be monitored during extruder operation and, in some cases, extrusion dies are inspected, removed, and cleaned following the end of the production run or upon shutting down to prevent damage to the die plate and pelletizer system. In some cases, extrusion dies may require maintenance prior to ending the production run due to mechanical failures and/or as product quality degrades to an unacceptable level. In either scenario, die maintenance typically involves stopping production and removing the die plate for replacement of nibs and tiles, and/or repair by manual polishing, paste polishing, grinding, and the like.

Systems and die face designs disclosed herein may include wear face elements (such as single-hole nib 222 in FIG. 2, multi-hole nib 422 in FIG. 4, or tile 522 in FIG. 5) constructed from PCD that increase the wear resistance and service life of the die plate. PCD, also known as a diamond abrasive compact, is composed of a mass of diamond particles and assembled by direct diamond-to-diamond bonding. PCD may include from about 85% to about 95% by volume diamond with the balance being a second phase containing a metallic binder such as cobalt, nickel, iron or an alloy containing one or more such metals disposed within interstitial regions of the PCD microstructure. In some cases, the PCD may be treated to remove substantially all of the metallic binder, thereby resulting in formation of thermally stable PCD.

PCD materials disclosed herein may be used to fabricate one or more elements of the die face and/or other components subject to mechanical wear, which may enhance the mechanical strength and service life of the polymer extrusion system. PCD elements (including PCD wear face elements) possess a number of mechanical properties suited for extrusion applications including high hardness and toughness values, low coefficient of friction, and increased abrasion resistance, particularly when compared to components constructed from stainless steel and similar metals.

Particularly, inclusion of PCD elements in the die face can increase wear resistance for surfaces in contact with pelletizer blades during extrusion. Likewise, including PCD elements on one or more pelletizer blades in contact with (or proximity of) the die face can bring about the same effect. Thus, embodiments herein also contemplate inclusion of PCD elements on (1) the die face, (2) one or more of the pelletizer blades, or (3) both. With respect to the die plate, PCD elements and materials can be used to construct any portion of the die plate, including the exit face or any wear face designs discussed above including single- and multi-hole nibs, tiles, monolithic wear faces, and any other wear face variant compatible with the selected extruder and pelletizer. Examples specific to pelletizer blades include the use of PCD elements to construct a monolithic pelletizer blade, or any component thereof, such as a cutting surface or insert.

During manufacture, a PCD element may be constructed by contacting diamond powder with a metal substrate, such as a cobalt cemented tungsten carbide substrate. Suitable diamond powders useful for forming PCD elements include those having an average diameter grain size within the range from sub-micrometer size (e.g., nano-scale) up to 100 μm; such as from a low of any one of 1, 10, or 15 μm to a high of any one of 40, 50, 60, 70, 80, 90, or 100 μm. The diamond powder can contain grains having a mono or multi-modal size distribution. In the event that diamond powders are used having differently-sized grains, the diamond grains may be mixed together by conventional processes, such as by ball or attritor milling for a sufficient time to ensure good, uniform distribution. The diamond powder and metal substrate are processed under heat and pressure such that the metal permeates the diamond powder. In this process, additional diamond may be formed on the crystal faces between the diamond particles, forming a network of bonded diamond and a continuous metal phase that bonds the diamond to the substrate. PCD elements may be formed into any suitable shape for incorporation with a die face and/or pelletizer blade using any acceptable method known in the art.

PCD elements may have a layered structure having a PCD layer affixed to a metal substrate, where the thickness of the PCD layer of is within a range of about 0.3 mm to about 7 mm (such as from a low of any one of 0.3, 0.4, or 0.5 mm to a high of any one of 5, 6, or 7 mm). PCD elements may have an overall thickness (including both substrate and PCD layers) of about 1 mm to about 10 mm (such as from a low of any one of 1, 1.5, 2, or 2.2 mm to a high of any one of 5, 6, 7, 8, 9, or 10 mm).

When incorporated into a pelletizer blade, the PCD blade element (including both substrate and PCD layers) may have an overall thickness ranging from about 5 mm to about 20 mm, about 5 mm to about 17 mm, or about 5 mm to about 15 mm. When used to construct a monolithic pelletizer blade the coverall thickness of the PCD element may be of any suitable dimensions compatible with the selected pelletizer.

Attachment of a PCD element (or PCD wear face or PCD exit face) to the die plate may be by any suitable technique, including attachment of PCD element to a die plate by high pressure and high temperature (HPHT) processing, welding, brazing, adhesion, bolting, or friction-based attachments (e.g., shrink or interference fit). The attachment methodology may vary depending on the composition of the metal die plate, which is often constructed from a metal such as stainless steel, tungsten alloy, and the like. In some cases, PCD elements may be removable from the die plate, allowing an operator to replace the die plate or PCD wear face elements separately. Removal of the wear face elements from the die face may be done when the die plate is removed or mounted on the extruder.

Systems and die face designs disclosed herein may prolong the service life of an extruder die beyond that for a comparative design constructed from other metals, where service life is defined as the time span between installation of a new or refurbished die until die removal. Die service life may be measured in months or, in some cases, tons processed per die hole. Die plates incorporating PCD elements may extend the service life of a die by about at least 10%, about at least 20%, or about at least 30%, or in a range from about 10% to about 30%. While an example range is provided, the service life may more or less depending on a number of factors such as polymer type and grade, die geometry, pelletizer settings, and extruder type.

### Polymer Systems

Die plate and exit face designs disclosed herein may be employed on any compatible extruder die face and the type of polymer system being extruded is not particularly limited. Polymer systems may include any thermoplastic and/or elastomer suitable for extrusion. Examples of suitable polymer systems include polyolefins such as low, intermediate, or high density polyethylene, polypropylene, polybutene-1, poly-3-methylbutene-1, poly-4-methylpentane-1, copolymers of monoolefins with other olefins (mono or diolefins) or vinyl monomers such as ethylene-propylene copolymer or with one or more additional monomers, such as ethylene propylene diene monomer rubber, ethylene/butylene copolymer, ethylene/vinyl acetate copolymer, ethylene/ethyl acrylate copolymer, propylene/4-methylpentene-1 copolymer, and the like.

Other polymer systems may include thermoplastic elastomers such as the “block” copolyesters from terephthalate, 1,4-butanediol and poly(tetramethylene ether)glycol; polystyrene; polystyrene polyphenylene oxide blends; polyesters such as polyethylene terephthalate, poly 1,4-butylene terephthalate, poly 1,4-cyclohexyldim ethylene terephthalate, and poly 1,3-propylene terephthalate; polyamides such as nylon-6,6, nylon-6, nylon-12, nylon-11, and aromatic-aliphatic copolyamides; polycarbonates such as poly bisphenol-A carbonate; fluorinated polymers such as copolymers of tetrafluoroethylene and hexafluoropropylene, polyvinyl fluoride, copolymers of ethylene and vinylidene fluoride or vinyl fluoride; polysulfides such as poly p-phenylene sulfide; polyetherketones; polyetheretherketones; polyetherketoneketones; polyetherimides; acrylonitrile-1,3-butadiene-styrene copolymers; (meth)acrylic polymers such as polymethyl methacrylate; and chlorinated polymers such as polyvinyl chloride.

Polymer systems may also include extrudable elastomers, including natural rubber, polyisobutylene, butyl, chlorobutyl, polybutadiene, butadiene-styrene, ethylene-propylene, ethylene-propylene diene terpolymer elastomers and mixtures thereof with each other and with thermoplastic polymers. Blends of any of the above suitable polymer systems are also within the scope of this disclosure. Particular embodiments may involve the extrusion of polyethylene polymers, that is, polymers having at least 85 wt % ethylene-derived units, such as at least 87 wt % or at least 90 wt % (as in the case of ethylene-α-olefin copolymers such as ethylene-butene, ethylene-hexene, or ethylene-octene copolymers), such as Ziegler-Natta or metallocene-catalyzed linear low density polyethylene polymers (LLDPE). Furthermore, polymers for extrusion (including the just-mentioned polyethylene polymers) may be produced using any suitable polymerization process for producing extrudable polymer product, including (1) gas-phase polymerization processes, including fluidized bed, horizontal stirred bed, and vertical stirred bed reactors, (2) bulk processes, including liquid pool and loop reactors, (3) slurry processes, including continuous stirred-tank, batch stirred-tank, loop and boiling butane reactors, (4) tubular processes, (5) autoclave processes, and/or (6) solution processes.

Embodiments disclosed herein include:

A. Die plates for polymer extrusion comprising: a die plate having an entrance face for accepting a polymer flow and an exit face for extruding one or more polymer strands, wherein the exit face comprises at least one element constructed from polycrystalline diamond.

B. Systems for extruding polymer, comprising: an extruder; a die plate attached to an outlet of the extruder and having (i) an entrance face for accepting a polymer flow and (ii) an exit face for extruding one or more polymer strands; and an array of blades configured to rotate so as to contact and slide along the surface of the die exit face, thereby cutting the one or more polymer strands extruded therethrough; wherein (a) the exit face. (b) the blade array, or (c) each of the exit face and the blade array comprises at least one element constructed from polycrystalline diamond.

C. Methods of extruding polymer, comprising: extruding a molten polymer through a die comprising an exit face constructed at least in part from polycrystalline diamond and attached to an outlet of an extruder.

Embodiments A, B, and C may have one or more of the following additional elements in any combination.

Element 1: wherein the at least one element comprises a nib embedded in the exit face and defining at least one extrusion orifice.

Element 2: wherein the at least one element comprises a multi-hole nib embedded in the exit face and defining at least one extrusion orifice.

Element 3: wherein the at least one element comprises a tile embedded in the exit face and defining at least one extrusion orifice.

Element 4: wherein the at least one element is affixed to the exit face by welding, brazing, adhesion, bolting, or friction-based attachment.

Element 5: wherein the at least one element is a monolithic wear face that substantially covers the exit face.

Element 6: wherein the at least one element has a total thickness in the range of about 1 mm to about 10 mm.

Element 7: wherein the at least one element is affixed to the exit face by welding, brazing, adhesion, bolting, or friction-based attachment.

Element 8: wherein the polycrystalline diamond element is affixed to the exit face or one or more blades in the blade array by welding, brazing, adhesion, bolting, or friction-based attachment.

Element 9: wherein the molten polymer is selected from a group consisting of low density polyethylene, intermediate density polyethylene, high density polyethylene, polypropylene, polybutene-1, poly-3-methylbutene-1, poly-4-methylpentane-1, ethylene-propylene, ethylene propylene diene monomer rubber, ethylene/butylene copolymer, ethylene/vinyl acetate copolymer, ethylene/ethyl acrylate copolymer, propylene/4-methylpentene−1 copolymer, poly(tetramethylene ether)glycol, polystyrene, polystyrene polyphenylene oxide blends, polyesters, polyamides, aromatic-aliphatic copolyamides, polycarbonates, polyvinyl fluoride, copolymers of ethylene and vinylidene fluoride or vinyl fluoride, polysulfides, polyetherketones, polyetheretherketones, polyetherketoneketones, polyetherimides, acrylonitrile-1,3-butadinene-styrene copolymers, (meth)acrylic polymers, and chlorinated polymers.

Element 10: wherein the method further comprises pelletizing the molten polymer exiting the die by contacting the molten polymer with a pelletizer array constructed at least in part from polycrystalline diamond.

By way of non-limiting example, exemplary combinations applicable to A, B, and C include, but are not limited to, 1 and any one or more of 2 to 9; 2 and any one or more of 1 and 3 to 9; 3 and any one or more of 1 to 2 and 4 to 9; 4 and any one or more of 1 to 3 and 5 to 9; 5 and any one or more of 1 to 4 and 6 to 9; 6 and any one or more of 1 to 5 and 7 to 9; 7 and any one or more of 1 to 6 and 8 to 9; 8 and any one or more of 1 to 7 and 9; and 9 and any one or more of 1 to 8. Additional combinations applicable to C include 10 and any one or more of 1 to 9.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted. As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B. or only C, any combination of A, B, and C; and/or at least one of each of A, B, and C.

The use of directional terms such as above, below, upper, lower, upward, downward, left, right, and the like are used in relation to the illustrative embodiments as they are depicted in the figures, the upward direction being toward the top of the corresponding figure and the downward direction being toward the bottom of the corresponding figure.

What is claimed is:

1. A die plate for polymer extrusion comprising:
a die plate having an entrance face for accepting a polymer flow and an exit face for extruding one or more polymer strands, wherein the exit face comprises at least one element constructed from polycrystalline diamond.

2. The die plate of claim 1, wherein the at least one element comprises a nib embedded in the exit face and defining at least one extrusion orifice.

3. The die plate of claim 1, wherein the at least one element comprises a multi-hole nib embedded in the exit face and defining at least one extrusion orifice.

4. The die plate of claim 1, wherein the at least one element comprises a tile embedded in the exit face and defining at least one extrusion orifice.

5. The die plate of claim 1, wherein the at least one element is affixed to the exit face by welding, brazing, adhesion, bolting, or friction-based attachment.

6. The die plate of claim 1, wherein the at least one element is a monolithic wear face that substantially covers the exit face.

7. The die plate of claim 1, wherein the at least one element has an overall thickness in the range of about 1 mm to about 10 mm.

8. A system for extruding polymer, comprising:
an extruder;
a die plate attached to an outlet of the extruder and having (i) an entrance face for accepting a polymer flow and (ii) an exit face for extruding one or more polymer strands; and
an array of blades configured to rotate so as to contact and slide along the surface of the die exit face, thereby cutting the one or more polymer strands extruded therethrough;
wherein (a) the exit face, (b) the blade array, or (c) each of the exit face and the blade array comprises at least one element constructed from polycrystalline diamond.

9. The system of claim 8, wherein the exit face comprises at least one nib constructed from polycrystalline diamond.

10. The system of claim 8, wherein the exit face comprises at least one multi-hole nib constructed from polycrystalline diamond.

11. The system of claim 8, wherein the exit face comprises at least one tile constructed from polycrystalline diamond.

12. The system of claim 8, wherein the at least one element has an overall thickness in the range of about 1 mm to about 10 mm.

13. The system of claim 8, wherein the at least one element is affixed to the exit face or one or more blades in the blade array by welding, brazing, adhesion, bolting, or friction-based attachment.

14. A method of extruding polymer, comprising:
extruding a molten polymer through a die comprising an exit face constructed at least in part from polycrystalline diamond and attached to an outlet of an extruder.

15. The method of claim 14, wherein the exit face comprises at least one nib constructed from polycrystalline diamond.

16. The method of claim 14, wherein the exit face comprises at least one multi-hole nib constructed from polycrystalline diamond.

17. The method of claim 14, wherein the molten polymer is selected from a group consisting of low density polyethylene, intermediate density polyethylene, high density polyethylene, polypropylene, polybutene-1, poly-3-methylbutene-1, poly-4-methylpentane-1, ethylene-propylene, ethylene propylene diene monomer rubber, ethylene/butylene copolymer, ethylene/vinyl acetate copolymer, ethylene/ethyl acrylate copolymer, propylene/4-methylpentene-1 copolymer, poly(tetramethylene ether)glycol, polystyrene, polystyrene polyphenylene oxide blends, polyesters, polyamides, aromatic-aliphatic copolyamides, polycarbonates, polyvinyl fluoride, copolymers of ethylene and vinylidene fluoride or vinyl fluoride, polysulfides, polyetherketones, polyetheretherketones, polyetherketoneketones, polyetherimides, acrylonitrile-1,3-butadiene-styrene copolymers, (meth)acrylic polymers, and chlorinated polymers.

18. The method of claim 1, wherein the exit face comprises a polycrystalline diamond element having an overall thickness in the range of about 1 mm to about 10 mm.

19. The method of claim 18, wherein the polycrystalline diamond element is affixed to the exit face by welding, brazing, adhesion, bolting, or friction-based attachment.

20. The method of claim 14, further comprising pelletizing the molten polymer exiting the die by contacting the molten polymer with a pelletizer array constructed at least in part from polycrystalline diamond.
